(19) United States
(12) Patent Application Publication
(10) Pub. No.: US 2010/0073259 A1
(43) Pub. Date: Mar. 25, 2010

(54) Antenna device

(75) Inventor: Shih Lin Huang, Tauyuan Hsien (TW)

Correspondence Address: CHARLES E. BAXLEY, ESQUIRE, 90 JOHN STREET, SUITE 309, NEW YORK, NY, 10038, US

(73) Assignee: Joymax Electronics Co., Ltd.

(21) Appl. No.: 11/903,885

(22) Filed: Sep. 25, 2008

(51) Int. Cl. H01Q 1/36

(52) U.S. Cl. 343/895

(57) ABSTRACT

An antenna device includes two antenna members each having a support member disposed on a transmission facility, and two helical antenna elements disposed on the support members and arranged in different directions or opposite to each other and having polar directions preferably arranged perpendicular to each other for facilitating a throughput or signal transmitting effect and for increasing the isolation. The helical antenna elements each may include a terminal electrically coupled to a cable, and each may include two or more helical conductors and one or more non-conducting spaces disposed between the helical conductors.

### BACKGROUND OF THE INVENTION

1. Field of the Invention

The present invention relates to an antenna device, and more particularly to an antenna device including two or more antenna members having helical antenna elements arranged in different direction for facilitating or promoting the throughput or signal transmitting effect and for increasing the isolation for the antenna device.

2. Description of the Prior Art

Typical antenna devices may comprise two or more antenna members for multi-transceiver mobile transmission purposes. For example, U.S. Pat. No. 6,560,443 to Vaisanen et al. discloses one of the typical antenna sharing switching circuitries for multi-transceiver mobile terminals.

However, the antenna members are simply disposed side by side or close to each other such that the isolation between the antenna members may be decreased, and the throughput or signal transmitting effect for the typical antenna devices may also be decreased.

U.S. Pat. No. 7,038,636 to Larouche et al. discloses another typical helical antenna including a helix supported by a helix support. However, the typical helical antenna includes a single helix supported by a helix support, and the throughput or signal transmitting effect for the typical helical antenna may not be increased.

The present invention has arisen to mitigate and/or obviate the afore-described disadvantages of the conventional multi-transceiver antenna devices.

### SUMMARY OF THE INVENTION

The primary objective of the present invention is to provide an antenna device including two or more antenna members having helical antenna elements arranged in different direction for facilitating or promoting the throughput or signal transmitting effect and for increasing the isolation for the antenna device.

In accordance with one aspect of the invention, there is provided an antenna device comprising a first antenna member including a first support member disposed on a transmission facility, and including a first helical antenna element disposed on the first support member and having a polar direction, and a second antenna member including a second support member disposed on the transmission facility, and including a second helical antenna element disposed on the second support member and having a polar direction, and the first helical antenna element and the second helical antenna element are arranged in different directions or opposite to each other.

The first helical antenna element includes a terminal electrically coupled to a cable. The second helical antenna element may also include a terminal electrically coupled to a cable.

The first helical antenna element includes at least two helical conductors and a non-conducting space provided therein. The second helical antenna element may also include at least two helical conductors and a non-conducting space provided therein.

The first helical antenna element is inclined from upper left toward lower right, and the second helical antenna element is inclined from upper right toward lower left; or alternatively, the first helical antenna element is inclined from upper right toward lower left, and the second helical antenna element is inclined from upper left toward lower right.

The polar directions of the first helical antenna element and the second helical antenna element are preferably perpendicular to each other.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an antenna device in accordance with the present invention;

FIG. 2 is a partial exploded or plan schematic view of the antenna device;

FIG. 3 is a partial exploded or plan schematic view similar to

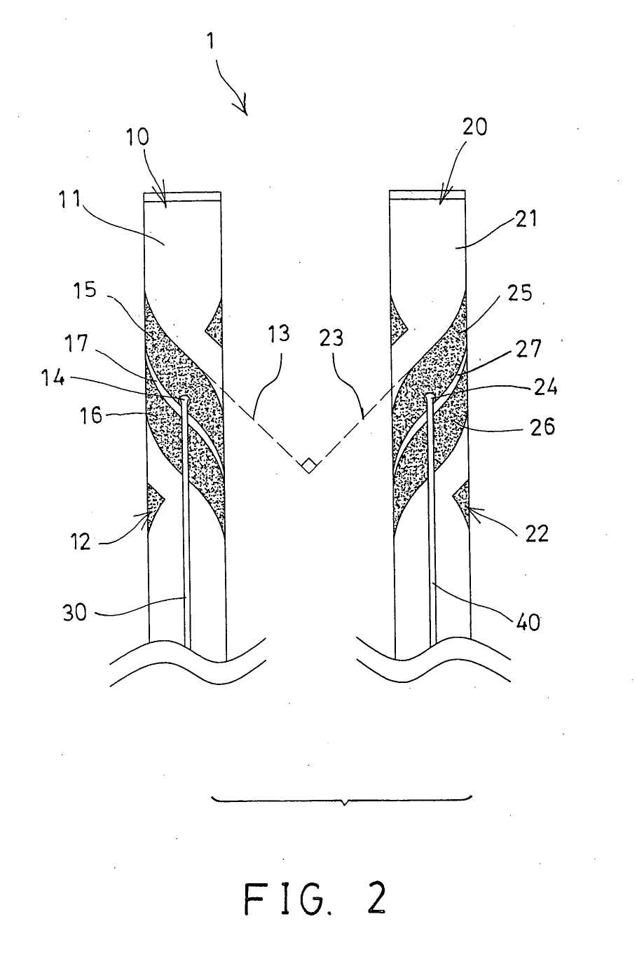

FIG. 2 illustrating the other arrangement of the antenna device; and

FIG. 4 is a chart illustrating the operation or the test result of the antenna device.

### DETAILED DESCRIPTION OF THE PREFERRED EMBODIMENT

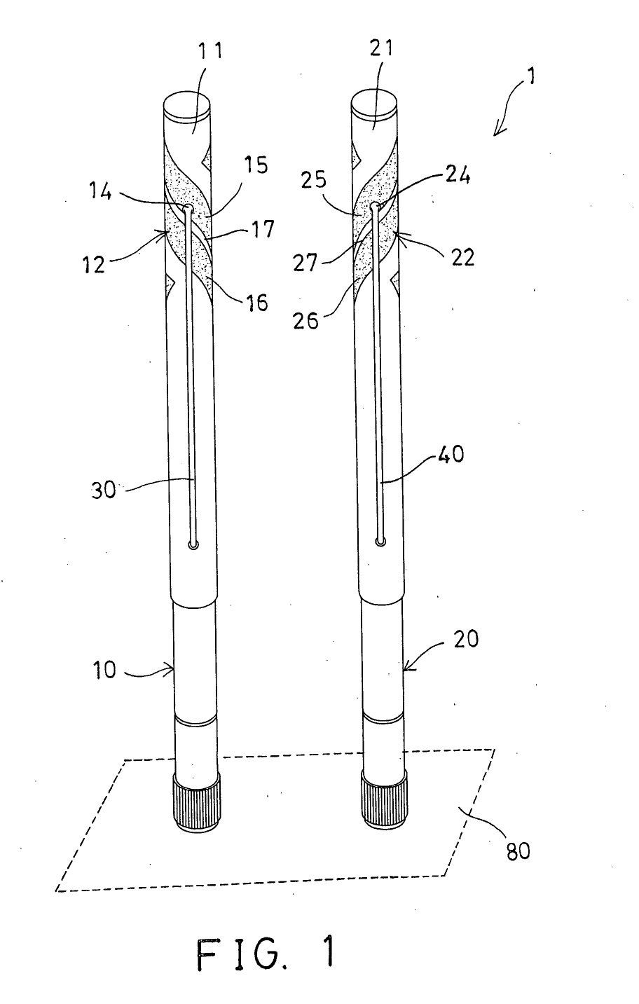

Referring to the drawings, and initially to FIGS. 1 and 2, an antenna device 1 in accordance with the present invention comprises one or more pairs, or two or more antenna members 10, 20 attached to or disposed or supported on a support base or mobile transmission facility 80 for signal transmitting and/or receiving purposes, the antenna members 10, 20 each include a longitudinal or tubular or cylindrical support body or member 11, 21, and one or more helix or helical antenna elements 12, 22 attached or printed or disposed or applied onto the outer peripheral portions of the support members 11, 21 respectively, and the helical antenna elements 12, 22 of the support members 11, 21 are disposed or arranged opposite to each other or in different directions.

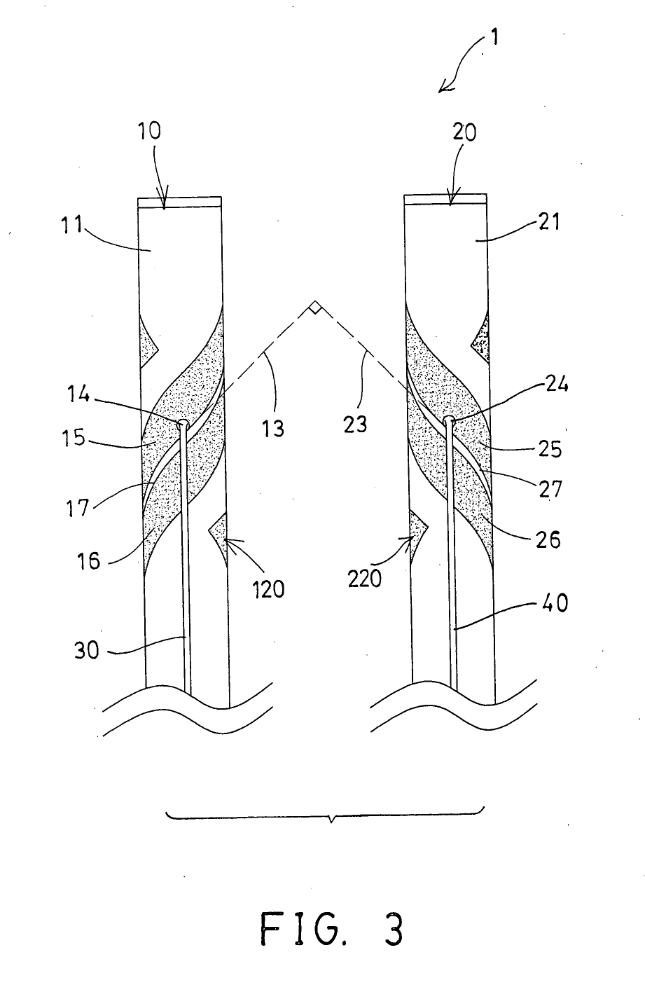

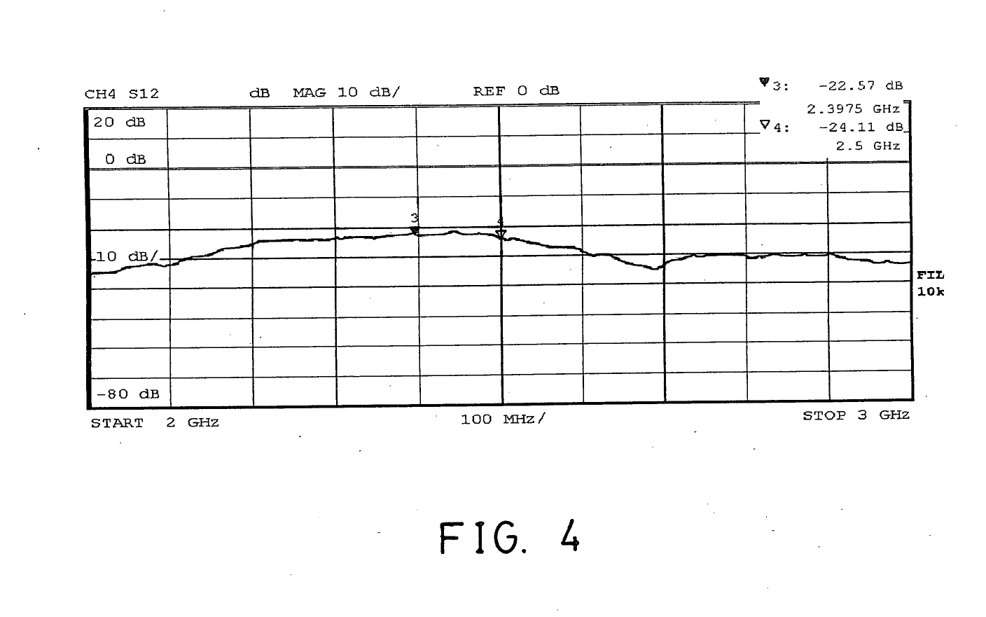

For example, as shown in FIG. 2, the helical antenna element 12 of the support member 11 is inclined from the upper left toward the lower right, and the helical antenna element 22 of the other support member 21 is inclined from the upper right toward the lower left, alternatively, as shown in FIG. 3, the helical antenna element 120 of the support member 11 may be inclined from the upper right toward the lower left, and the helical antenna element 220 of the other support member 21 may be inclined from the upper left toward the lower right. The helical antenna elements 12, 120, 22, 220 each include a polar direction 13, 23, and it is preferable, but not necessarily that the polar directions 13, 23 of the helical antenna elements 12, 120, 22, 220 are perpendicular to each other, best shown in FIGS. 2, 3.

It is further preferable that the helical antenna elements 12, 22 each include a terminal 14, 24 electrically coupled to an electrical or transmission wire or cable 30, 40 respectively for signal transmitting and/or receiving purposes, and the helical antenna elements 12, 22 each may include one or more helical conductors 15, 16; 25, 26, and one or more insulators or non-conducting spaces 17, 27 provided or formed between the helical conductors 15, 16; 25, 26 respectively for spacing the helical conductors 15, 16; 25, 26 from each other.

In operation, as shown in FIG. 4, when operating or testing the antenna members 10, 20 of the antenna device 1 in or with different frequencies, the isolation for the antenna device 1 is increased or better than that of the typical antenna devices, for example, when tested with a frequency of 2.4 GHz, the isolation is −22.57 dB, and the isolation for the typical antenna devices is normally around −15.87 dB; when tested with another frequency of 2.5 GHz, the isolation is −24.11 dB, and the isolation for the typical antenna devices is normally around −13.98 dB. In addition, the throughput or signal transmitting effect for the antenna device 1 in accordance with the present invention may also be suitably facilitated or promoted or increased as compared with that of the typical antenna devices.

Accordingly, the antenna device in accordance with the present invention includes two or more antenna members having helical antenna elements arranged in different direction for facilitating or promoting the throughput or signal transmitting effect and for increasing the isolation for the antenna device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An antenna device comprising:
a first antenna member including a first support member disposed on a transmission facility, and including a first helical antenna element disposed on said first support member and having a polar direction, and
a second antenna member including a second support member disposed on the transmission facility, and including a second helical antenna element disposed on said second support member and having a polar direction, and
said first helical antenna element and said second helical antenna element being arranged in different directions.

2. The antenna device as claimed in claim 1, wherein said first helical antenna element includes a terminal electrically coupled to a cable.

3. The antenna device as claimed in claim 1, wherein said second helical antenna element includes a terminal electrically coupled to a cable.

4. The antenna device as claimed in claim 1, wherein said first helical antenna element includes at least two helical conductors and a non-conducting space provided therein.

5. The antenna device as claimed in claim 1, wherein said second helical antenna element includes at least two helical conductors and a non-conducting space provided therein.

6. The antenna device as claimed in claim 1, wherein said first helical antenna element is inclined from upper left toward lower right, and said second helical antenna element is inclined from upper right toward lower left.

7. The antenna device as claimed in claim 1, wherein said first helical antenna element is inclined from upper right toward lower left, and said second helical antenna element is inclined from upper left toward lower right.

8. The antenna device as claimed in claim 1, wherein said polar directions of said first helical antenna element and said second helical antenna element perpendicular to each other.
